(19) United States
(12) Patent Application Publication
(10) Pub. No.: US 2008/0266838 A1
(43) Pub. Date: Oct. 30, 2008

(54) Illuminated helmet

(76) Inventor: Henkel Lin, Taichung Hsien (TW)

Correspondence Address: CHARLES E. BAXLEY, ESQUIRE, 90 JOHN STREET, SUITE 309, NEW YORK, NY, 10038, US

(21) Appl. No.: 11/789,903

(22) Filed: Apr. 26, 2007

(51) Int. Cl. F21V 21/084; A42B 1/00

(52) U.S. Cl. 362/105; 2/410

(57) ABSTRACT

An illuminated helmet has a body, an illuminating device and a shell. The body is plastic foam and has an outer surface. The illuminating device is mounted on the outer surface of the body and has a flexible ribbon cable, multiple LEDs, a battery cartridge, and a switch. The switch is mounted on the body and is connected with the multiple LEDs and the battery cartridge by using the flexible ribbon cable. The shell is a plastic sheet and has an inner surface. The ribbon cable is flexible and thin, allowing the ribbon cable to be mounted smoothly on the outer surface of the body without breaking so the shell caps the body well and will not break.

### BACKGROUND OF THE INVENTION

1. Field of Invention

The present invention relates to a helmet, and more particularly to a protective helmet with warning illumination.

2. Description of the Related Art

A helmet is necessary to minimize injury to a person's head when skating, skateboarding, riding bicycles or participating in similar activities. Generally, a bicycle helmet comprises a body and a shell. The body is normally plastic foam and has an inner surface and an outer surface. The inner surface is contoured to fit a person's head. The shell is mounted onto the outer surface of the body.

To improve safety of riding at night, some helmets have been equipped with warning lights. For instance, a well known luminary helmet includes a light-guide line, an LED module, a battery, an electric wire, a control circuit and a body. The body has an outer surface. The light-guide line, LED module, battery, electric wire and control circuit are mounted on the outer surface of the body. However, because the outer surface of the body is somewhat spherical, the light-guide line and electric wire are not easily bonded to the outer surface of the body smoothly. The electric wire also breaks easily when bent to conform to the outer surface of the body.

To overcome the shortcomings, the present invention provides an illuminated helmet to mitigate or obviate the aforementioned problems.

### SUMMARY OF THE INVENTION

The primary objective of the present invention is to provide an illuminated helmet comprising a body, an illuminating device and, a shell and a ribbon cable that is smoothly mounted on the surface of the body and will not break and allow the shell to fit the body well.

An illuminated helmet comprising a body, an illuminating device and a shell. The body is a plastic foam helmet and has an inner surface and an outer surface. The inner surface of the body is a recess designed for containing a human head. The illuminating device is mounted on the outer surface of the body and has a ribbon cable, multiple LEDs, a battery cartridge, and a switch. The switch is mounted on the body and connected with the multiple LEDs and the battery cartridge by using the ribbon cable. The shell is a plastic sheet and has an inner surface. The ribbon cable is flexible and thin, allowing the ribbon cable to be mounted smoothly on the outer surface of the body without breaking so the shell caps the body well. Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an illuminated helmet in accordance of the present invention;

FIG. 2 is an exploded perspective view of the illuminated helmet in FIG. 1;

FIG. 3A is a top view of a body of the illuminated helmet in FIG. 1;

FIG. 3B is a top view of a shell of the illuminated helmet in FIG. 1; and

FIG. 4 is an enlarged rear view in partial section of the illuminated helmet in FIG. 1.

### DETAILED DESCRIPTION OF THE INVENTION

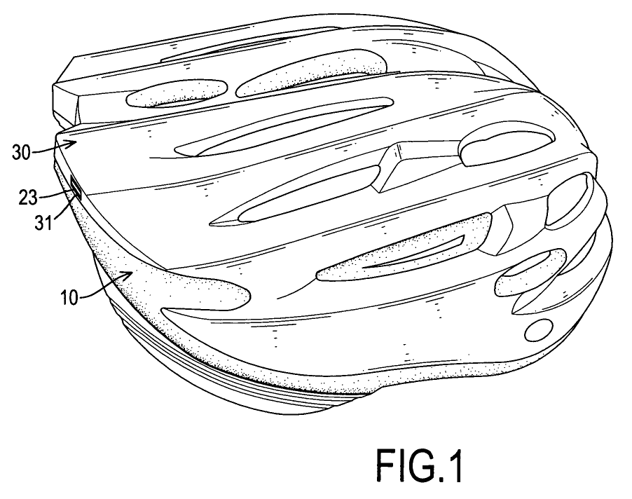

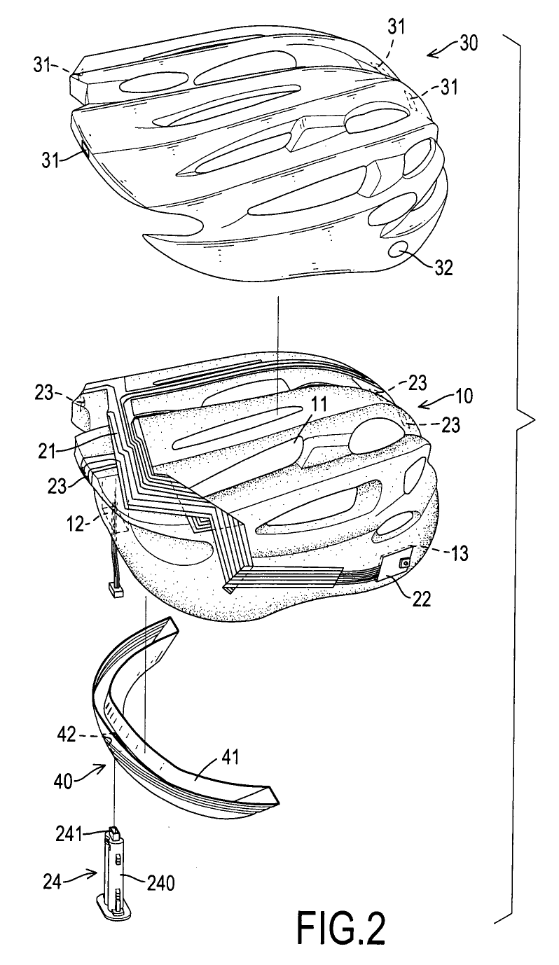

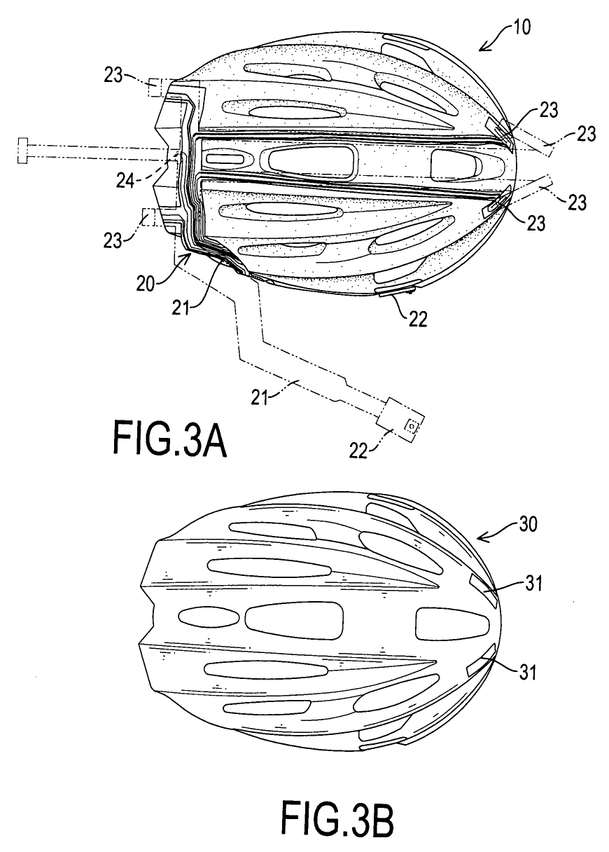

With reference to FIGS. 1, 2, 3A and 3B, an illuminated helmet comprises a body (10), an illuminating device (20), a shell (30) and an optional bumper (40).

The body (10) is plastic foam and has multiple breathing-holes (11), a battery compartment (12), a switch recess (13), an inner surface, an outer surface and a bottom edge. The inner surface is a recess designed for containing a human head and connects to the outer surface to form the bottom edge. The outer surface has a side surface, a front surface and a rear surface. The bottom edge has a rear. The multiple breathing-holes (11) are formed through the body (10). The battery compartment (12) is formed on the rear of the bottom edge. The switch recess (13) is formed in the side surface of the outer surface of the body (10).

The illuminating device (20) has a switch (22), multiple LEDs (23), a battery cartridge (24) and a ribbon cable (21).

The switch (22) is mounted on the body (10), maybe in the switch recess (13) and is connected to the multiple LEDs (23) and the battery cartridge (24) by the ribbon cable (21).

The multiple LEDs (23) are mounted on the body (10) and may be placed on the front, side or rear surface of the outer surface of the body (10).

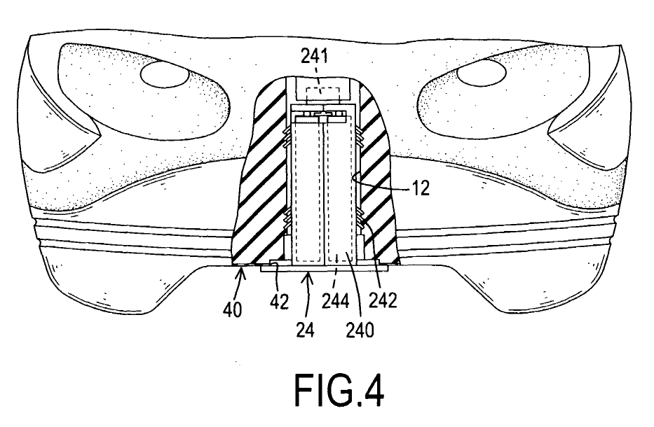

With further reference to FIG. 4, the battery cartridge (24) is mounted on the body (10) and may be mounted in the battery compartment (12) and has a battery (244), an inner container, an outer surface, a connector (241) and optional multiple stoppers (242).

The battery (244) is mounted in the inner container. The connector (241) is mounted on the outer surface of the battery cartridge (24) and connects to the ribbon cable (21). The multiple stoppers (242) are tooth-like rods formed on the outer surface of the battery cartridge (24) towards the battery hole and each has a free end. The multiple stoppers (242) prevent the battery cartridge (24) from slipping out of the battery compartment (12) when it is mounted in the battery compartment (12).

The ribbon cable (21) is a flexible power line that is mounted on the outer surface of the body (10), and may be bonded smoothly and may be folded to avoid the breathing-holes (11). The shell (30) is plastic and has optional multiple holes, multiple windows (31), an optional film (32), an inner surface and an outer surface. The inner surface of the shell (30) and the outer surface of the body (10) have the same shape so that the shell (30) caps the body (10). The multiple holes of the shell (30) are aligned respectively with the multiple breathing-holes (11) of the body (10). The windows (31) are transparent, are formed on the outer surface of the shell (30) and are aligned respectively to the multiple LEDs (23). The film (32) is formed on the outer surface of the shell (30), aligns with the switch recess (13), allowing a person to press the switch (22).

The bumper (40) is plastic and has a hollow (41), a battery hole (42), an outer wall, an inner wall and a bottom edge. The outer wall has an edge and the inner wall has an edge that connects to form the bottom edge and the hollow (41). The battery hole (42) is formed through the bottom edge of the bumper (40) and is aligned with the battery compartment (12) of the body (10). The battery hole (42) is used to mount the battery cartridge (24).

Hence, the ribbon cable (21) is flexible and thin, allowing the ribbon cable (21) to be mounted smoothly on the outer surface of the body (10) without breaking so the shell (30) caps the body (10) well.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An illuminated helmet comprising
a body being plastic foam and having
an inner surface being a recess;
an outer surface having;
two side surfaces;
a rear surface; and
a front surface;
a bottom edge having a rear part and being a connecting edge to the inner surface and the outer surface of the body; and
a battery compartment being formed on the outer surface of the body;
an illuminating device having
a ribbon cable being a flexible power wire and being mounted on the outer surface of the body;
multiple LEDs being mounted on the outer surface of the body and connecting to the ribbon cable;
a battery cartridge being mounted on the body and having
a battery;
an inner container;
an outer surface;
a connector being mounted on the outer surface of the battery cartridge and being connected with the ribbon cable; and
a switch being mounted in the body and being connected with the multiple LEDs and the battery cartridge by the ribbon cable; and
a shell being plastic and having
an inner surface having the same shape corresponding to the outer surface of the body and capping with the body;
an outer surface; and
multiple windows being transparent, being formed on the outer surface of the shell and being aligned with the multiple LEDs.

2. The illuminated helmet as claimed in claim 1, wherein the multiple LEDs are mounted on the front of the outer surface of the body.

3. The illuminated helmet as claimed in claim 1, wherein the multiple LEDs are mounted on the rear of the outer surface of the body.

4. The illuminated helmet as claimed in claim 1, wherein a battery compartment is formed on the rear part of the bottom edge of the body.

5. The illuminated helmet as claimed in claim 2, wherein the body further has multiple breathing holes and the shell further has multiple holes aligning with the multiple breathing holes of the body.

6. The illuminated helmet as claimed in claim 5, wherein the shell further has a film being formed on the outer surface of the shell and being aligned with the switch.

7. The illuminated helmet as claimed in claim 6, wherein the body further has a switch recess being formed on the side surface of the outer surface of the body and the switch is mounted in the switch recess.

8. The illuminated helmet as claimed in claim 7, wherein the illuminated helmet further comprises a bumper connecting with the rear part of the bottom edge of the body and having
a hollow
a bottom edge;
an inner wall having an edge;
an outer wall having an edge being connected to the edge of the inner wall to form the bottom edge and the hollow; and
a battery hole being formed through the edge of the bumper and being aligned with the battery compartment; and
the battery cartridge being mounted in battery compartment of the body through the battery hole of the bumper.

9. The illuminated helmet as claimed in claim 8, wherein the battery cartridge further has multiple stoppers being tooth like rods each having a free end being towards to the battery hole.
